(19) United States
(12) Patent Application Publication
(10) Pub. No.: US 2015/0356658 A1
(43) Pub. Date: Dec. 10, 2015

(54) Systems And Methods For Serving Product Recommendations

(71) Applicant: Baynote, Inc., San Jose, CA (US)

(72) Inventor: Robin D. Morris, Palo Alto, CA (US)

(21) Appl. No.: 14/298,582

(22) Filed: Jun. 6, 2014

(51) Int. Cl. G06Q 30/06; G06Q 10/06

(52) U.S. Cl. CPC G06Q 30/0631; G06Q 10/06393

(57) ABSTRACT

Example systems and methods for serving product recommendations for key performance indicator (KPI) optimization are described. In one implementation, a method selects at least a first item from a set of items such that a first performance indicator among a plurality of performance indicators is improved as a result of a user purchasing the first item in response to viewing at least the first item on a webpage of a website. The method also displays a graphic or textual representation of at least the first item on the webpage as a recommendation to the user.

### TECHNICAL FIELD

The present disclosure relates to electronic commerce and, in particular, to systems and methods for serving product recommendations in electronic commerce (e-commerce).

### BACKGROUND

Internet retail sites often feature a “recommended products” section on category and product pages. There have been a consistent move in the industry away from hand-selected recommendations towards algorithmically generated recommendations. These algorithms can be broadly split into two categories, namely: the user-based category and the item-based category. User-based recommendations often come in the form of “users like you bought these items.” Item-based recommendations appears as “users who viewed this item also viewed those items,” and can be sub-divided into substitution and complementary items (“up-sell” and “cross-sell”).

Current product recommendations on e-commerce websites are, in general, based primarily on heuristics that typically take into account only information about user engagement with the product, in terms of views or lingers. They do not take into account any information about purchases of the product, nor are they able to target specific customer key performance indicators (KPIs).

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an example framework of the present disclosure.

FIG. 2 is a chart of example distributions of click-through rate of two products in accordance of the present disclosure.

FIG. 3 is a chart of example distributions of expected KPI of two products in accordance of the present disclosure.

FIG. 4 is a block diagram depicting an embodiment of a computing device configured to implement systems and methods of the present disclosure.

FIG. 5 is a flowchart diagram of an embodiment of a process in accordance of the present disclosure.

FIG. 6 is a flowchart diagram of another embodiment of a process in accordance of the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The present disclosure introduces the statistics necessary to develop the algorithms that can determine KPI-optimizing product recommendations, as well as the approximations needed to render the statistics and algorithms useful in practice. Details of the simplest practical algorithm are provided herein, with directions within the proposed framework that lead to true one-to-one personalization. The proposed statistical framework can be specialized to all of the scenarios in the two categories, namely the user-based category and the item-based category.

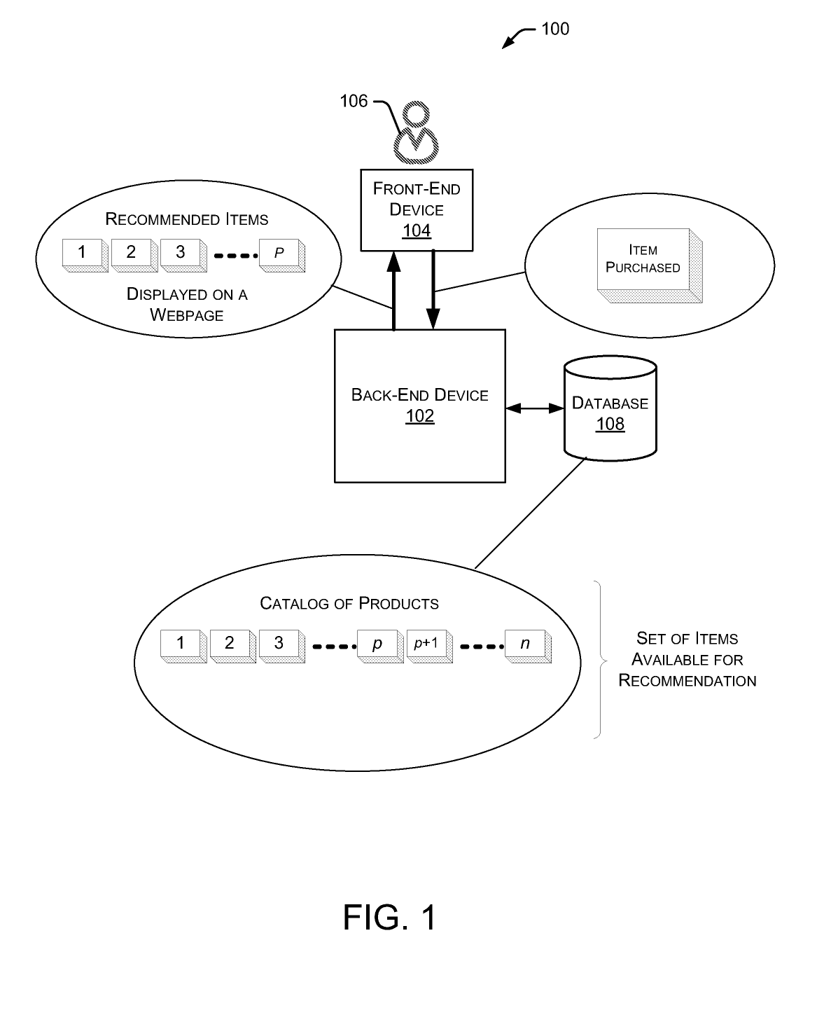

FIG. 1 is a block diagram depicting a framework 100 within which an example embodiment of the present disclosure may be implemented. Framework 100 includes back-end device 102 and front-end device 104. Back-end device 102 may include one or more processors that execute one or more sets of instructions to perform operations pertaining to algorithms described in the present disclosure. Database 108 may be communicatively coupled to back-end device 102 to cache or otherwise store some or all of the information and data received, collected and processed by the one or more processors of back-end device 102. In some implementations, database 108 may be an integral part of back-end device 102. For simplicity, database 108 and back-end device 102 are shown as two separate entities in FIG. 1 although they could be integral parts of an apparatus. Back-end device 102 may be any type of computing device such as, for example, one or more of a desktop computer, a workstation, a server, a mainframe computer, a portable device, etc. Front-end device 104 may be any type of user-interface device including, for example, a combination of one or more of a display panel, a monitor, a keyboard, a computer mouse, a stylus, a keypad, a touch-sensing screen, a voice-command device, or any suitable user-interface device conceivable in the future. Alternatively, front-end device 104 may be any type of computing device such as, for example, a desktop computer, a workstation, a laptop computer, a notebook computer, a tablet, a smartphone, a personal digital assistant, or any suitable handheld device.

Back-end device 102 and front-end device 104 may be integral parts of an apparatus or, alternatively, may be communicatively coupled directly or indirectly through one or more communication devices or one or more networks. In implementations where back-end device 102 and front-end device 104 communicate with one another through one or more networks, the one or more networks may include, for example, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN) or the Internet. In implementations where back-end device 102 and front-end device 104 communicate with one another through one or more networks including at least one wireless network, the at least one wireless network may be, for example, based on one or more wireless standards such as IEEE 802.11 standards, WiFi, Bluetooth, infrared, WiMax, 2G, 2.5G, 3G, 4G, Long Term Evolution (LTE), LTE-Advanced and/or future versions and/or derivatives thereof.

User 106, an online shopper also known as an e-commerce user, operates front-end device 104 to access back-end device 102. For example, through front-end device 104, user 106 browses a website of an e-commerce merchant, which is hosted on back-end device 102, and selects or otherwise identifies an item (referred to as “item of interest”) by taking an action with respect to the item of interest such as, for example, viewing or purchasing after viewing the item of interest. Back-end device 102 selects a subset of items as recommendations from a set of available items in a product catalog, where the viewing and purchasing of an item in the selected items in the subset by user 106 will optimize or at least improve a user-defined KPI. Graphic, textual or both graphic and textual representation of the selected items in the subset of items are displayed or otherwise presented on a webpage of the website to user 106 by front-end device 104. Although a single back-end device 102 is illustrated in FIG. 1, one of ordinary skill in the art would appreciate that, in various embodiments, back-end device 102 may be implemented as a system server, where a recommendation engine that provides product recommendations is run, and a web server that communicates with the system server and front-end device 104.

Database 108 maintains a database of a catalog of products set of items, e.g., items that are available for recommendation for purchase by the e-commerce merchant on its e-commerce website. As shown in FIG. 1, the set of items available for recommendation includes items 1, 2, 3, . . . n. When back-end device 102 receives from front-end device 104 a request for a webpage of the website by user 106, back-end device 102 accesses database 108 and selects a subset of candidate items as recommendations to be displayed on the webpage to user 106. The subset of candidate items as recommendations includes items 1, 2, 3, . . . p, where p<n, by utilizing algorithms described in the present disclosure based at least in part on known information about user 106 (if any) and known information about one or more other users. Back-end device 102 then communicates with front-end device 104 to display or otherwise present graphic and/or textual representation of the subset of candidate items on the requested webpage to user 106. The goal is that the KPI in concern is optimized or at least improved by displaying the selected subset of items as recommendations displayed to user 106, as the selected items tend to have a higher likelihood of being clicked on or even purchased by user 106.

To determine which products (interchangeably referred to as items hereinafter) to display to a user, e.g., user 106 of FIG. 1, as recommendations, the following probability needs to be determined for each potential set of recommendations {rⱼ}:

$$p ( \begin{matrix}user will purchase a product & user is shown \\ from the set \{ {r}_{j} \} & recommendation set \{ {r}_{j} \}\end{matrix} , {I}_{u} , {I}_{e} ) \qquad ( 1 )$$

where Iᵤ denotes everything that is known about user 106, and Iₑ denotes everything else that is known to be relevant to the problem of serving recommendations. In order to construct viable algorithms, approximations are made to the probability in expression (1).

The first approximation is to consider recommendations as independent, and to ignore the other recommendations being shown together with a particular recommendation. This reduces the number of recommendation sets from

$$( \begin{matrix}N \\ k\end{matrix} )$$

to a more manageable N, where N is the size of the catalog and k is the number of recommendations being displayed. Expression (1) then becomes expression (2) as follows:

$$p ( \begin{matrix}user will purchase & user is shown \\ product {r}_{j} & recommendation {r}_{j}\end{matrix} , {I}_{u} , {I}_{e} ) \qquad ( 2 )$$

To compute the probability in expression (2), all potential paths from the user being shown the recommendation until the point of purchase need to be considered. The next approximation is to consider the direct path—the user clicks on the recommendation and then buys the product. Expression (2) becomes expression (3) as follows:

p(user clicks on rⱼ and buys rⱼ|Iᵤ,Iₑ) (3)

Using a standard identity, expression (3) can be written as expression (4) as follows:

p(user buys rⱼ|user clicks on rⱼ,Iᵤ,Iₑ)×p(user clicks on rⱼ|Iᵤ,Iₑ) (4)

The first term in expression (4) is further approximated by replacing the conditioning on “user clicks on product rⱼ” with “user views product rⱼ”. It is assumed that the probability of a user buying an item once he/she is viewing the item does not depend on how he/she arrived at the product page. With the approximation, expression (4) becomes expression (5) as follows:

p(user buys rⱼ|user views rⱼ,Iᵤ,Iₑ)×p(user clicks on rⱼ|Iᵤ,Iₑ) (5)

Different approaches to recommendation algorithms reduce to different models for these two probabilities—what information is used about the user (Iᵤ) and the world (Iₑ), and what technique is to be used to estimate the probabilities. For example, information about the user could include some or all of the following: the details of his/her current session on the website (e.g., pages viewed, search terms used, items added to the shopping cart, items removed from the shopping cart, items purchased, etc.), details of previous interactions, location of the user, demographic details of the user, details of the user's social network, etc. Information about the world can include, for example, details of other users, more general information such as season, etc. Probabilities can be estimated using a host of statistical and machine learning techniques, including neural networks, regression trees, logistic regression, etc.

The absolute simplest case of expression (5) is when the only information known about the user is the page the user is currently viewing, pᵢ. With terms re-ordered, expression (5) becomes expression (6) as follows:

$$p ( \begin{matrix}user clicks & user is viewing \\ on rec {r}_{j} & rec {r}_{j} on page {p}_{i}\end{matrix} , {I}_{e} ) \times p ( \begin{matrix}user buys & user is viewing \\ {r}_{j} & page {r}_{j}\end{matrix} , {I}_{e} ) \qquad ( 6 )$$

The first term in expression (6) is the click-through-rate (CTR), and the second term can be considered the buy-through-rate (BTR), leading to algorithms collectively referred to as click-through-buy-through (CTBT) algorithms.

To model the CTR distribution, all users who are shown recommendation rⱼ on page pᵢ are considered. Each user is a Bernoulli trial—he/she either clicks on the recommendation, with probability θⱼᵢ, or he/she does not click, with probability (1−θⱼᵢ). Modeling the CTR distribution is thus determining the probability in expression (7) as follows:

p(θⱼᵢ|data from all users shown rec rⱼ on page pᵢ,Iₑ) (7)

In the Bayesian framework probability distributions encode knowledge, and the data available determine the precision of that knowledge. The CTR data is unlikely to result in a probability distribution with zero width as there will likely be some uncertainty in the knowledge of the “true” value of the CTR. This uncertainty represents an opportunity for adaptation to be described later. Expression (8), as follows, is obtained by applying Bayes rule to expression (7), where the posterior distribution for θⱼᵢ is proportional to the likelihood multiplied by the prior:

$$p ( \begin{matrix}{θ}_{ji} & \begin{matrix}data from all users \\ shown rec {r}_{j} on page {p}_{i}\end{matrix} , {I}_{e}\end{matrix} ) ∝ p ( \begin{matrix}data from all users & \\ shown rec {r}_{j} on page {p}_{i} & \end{matrix} {θ}_{ji} , {I}_{e} ) \times p ( {θ}_{ji} , {I}_{e} ) \qquad ( 8 )$$

Considering first the likelihood term, each user is a Bernoulli trial, so the likelihood is given by expression (9) as follows:

$$\begin{matrix}p ( \begin{matrix}data from all users & \\ shown rec {r}_{j} on page {p}_{i} & \end{matrix} {θ}_{ji} , {I}_{e} ) = {\prod }_{\begin{matrix}users who \\ clicked\end{matrix}} {\prod }_{\begin{matrix}users who \\ did not click\end{matrix}} ( 1 - {θ}_{ji} ) \\ = {{θ}_{ji}^{{NC}_{ji}} ( 1 - {θ}_{ji} )}^{{NI}_{ji} - {NC}_{ji}}\end{matrix} \qquad ( 9 )$$

where NCⱼᵢ is the number of times recommendation rⱼ is clicked on when shown on page pᵢ (the number of “successes”), and NIⱼᵢ is the number of times recommendation rⱼ is shown on page pᵢ (the number of “impressions”). Thus, NIⱼᵢ−NCⱼᵢ is the number of users who were shown recommendation rj on page pi but did not click on it (the number of “failures”).

For most combinations of recommendation rⱼ and page pᵢ, it is possible to have NIⱼᵢ=0 and NCⱼᵢ=0 (item j has never been recommended on page pᵢ, and so no click-through data is available). The second term on the right hand side in expression (8), the prior distribution over θⱼᵢ, is thus the only source of information regarding θⱼᵢ.

For some applications, where the number of product pages and the number of potential recommendations is small, it may suffice to assume a uniform prior for θ, and to therefore show randomly chosen recommendations, updating αⱼᵢ and βⱼᵢ online. The quality of the recommendations will improve as data is collected and converges quickly. An example of this type of application is deciding which stories to prioritize on the front page of a news website. For other applications, where the number of products is large, the number of potential recommendations is similarly large, and the customer requires recommendations that are at least “reasonable” during the initial learning phase, it is necessary to estimate an informative prior for θⱼᵢ from different aspects of “everything else we know” (Iₑ).

The conjugate prior for the likelihood in expression (9) is a prior that has a Beta distribution, which has the form of expression (10) as follows:

$$p ( θ ) = \frac{{{θ}^{α - 1} ( 1 - θ )}^{β - 1}}{B ( α , β )} \qquad ( 10 )$$

where α and β are the parameters of the distribution, and the Beta function,

$$B ( α , β ) = \frac{Γ ( α + β )}{Γ ( α ) Γ ( β )} .$$

To form an informative prior for the CTR distribution, it is necessary to estimate values for αⱼᵢ and βⱼᵢ. One way to do so is to estimate the values from general usage data. In one embodiment, the proxy for click-through used is co-viewing.

The parameter NVᵢ is defined as the number of users who viewed item I, and parameter NVⱼᵢ is defined as the number of users who viewed item I who also viewed item j. Then, αⱼᵢ and βⱼᵢ can be expressed as those shown in expressions (11) and (12) as follows:

αⱼᵢ=NVⱼᵢ+1 (11)

βⱼᵢ=NVᵢ−NVⱼᵢ+1 (12)

However, there may be a number of features, with expressing αⱼᵢ and βⱼᵢ as shown in expressions (11) and (12), which are undesirable. Typically, the values of NVᵢ will be very large for a heavily-trafficked website, resulting in a very narrow prior distribution for θ, which requires a similarly large number of impressions before the click-through data has a significant effect on the distribution of θ. One solution in accordance with the present disclosure is to apply a soft-threshold function to NVᵢ and NVⱼᵢ which limits the prior to be equivalent to the action of several hundred pseudo-visitors to the website. This results in prior distributions for θ which provide reasonable initial recommendations and also allow for learning when combined with click-through data. The viewed counts after soft thresholding can be denoted as NV′ᵢ and NV′ⱼᵢ.

The data on co-viewing may not be on the same scale as the click-through data. For example, multiple recommendations are typically shown on a product page, so it is expected that the actual CTRs to be lower than the prior rate determined above. While in principle this is not a problem—eventually the click-through data will overwhelm the prior—in practice it may lead to an extended learning period during which the recommendation quality tends to be very poor. There are two cases, namely where the prior overestimates the actual CTR and where the prior underestimates the actual CTR.

When the prior overestimates the actual CTR, initially the recommendations with the largest prior probability will be displayed. As click-through data is collected, the posterior distribution for those items shown as recommendations will be reduced, and other items, with priors larger than the posteriors for the items shown so far, will be shown. These new items will collect click-through data, and their posterior distributions will also be reduced. Eventually, the entire set of potential recommendations will have been displayed, at which point the optimal recommendations will be shown. However, it may take an unacceptably long time to work through a large product set, and during this time the quality of the recommendations is likely to be poor.

When the prior underestimates the actual CTR, those items with the largest prior value of θ will receive positive feedback, and will be the only recommendations ever shown.

Scaling of the prior is thus seen to be very important to the success of any CTBT algorithm. The prior for the CTR of recommendation j on page pᵢ is p(θⱼᵢ|Iₑ), and typically this can be constructed for a very large subset of all items in the catalog. The set is defined as P(i)={all items j for which the prior click-through rate on page i can be constructed}. The likelihood is only available for those items that have actually been recommended on a particular page, and this will be a much smaller subset of the catalog, and this set is denoted as [symbol] (i). For each element of [symbol] (i) the mode of the prior is given by

$${\hat{θ}}_{ji}^{P} = \frac{{NV}_{ji}}{{NV}_{i}} .$$

For each item for which click-through data is available, the maximum likelihood estimate of the CTR is

$${\hat{θ}}_{ji}^{L} = \frac{{NC}_{ji}}{{NI}_{ji}} .$$

The strategy for resealing the prior is to find the item j which has the maximum value of \hat{θ}ⱼᵢ^{L} for each page pᵢ. The scale factor is defined as

$${s}_{i} = \frac{{\hat{θ}}_{ji}^{L}}{{\hat{θ}}_{ji}^{P}} .$$

The resealed prior distribution is formed by defining the scaled prior using NV′ᵢ and NV*ⱼᵢ=sᵢ×NV′ⱼᵢ. Theses scaled, soft-thresholded counts are used to determine the parameters \hat{α}ⱼᵢ and \hat{β}ⱼᵢ that define the Beta distribution used as the prior.

An expression (13), as follows, can be obtained by combining the likelihood in expression (9) with the Beta distribution prior results in the posterior distribution:

$$\begin{matrix}p ( {θ}_{ji} \vert … ) ∝ {{θ}_{ji}^{{NC}_{ji}} ( 1 - {θ}_{ji} )}^{{NI}_{ji} - {NC}_{ji}} \times {{θ}_{ji}^{{\hat{α}}_{ji} - 1} ( 1 - {θ}_{ji} )}^{{\hat{β}}_{ji} - 1} \\ = {{θ}_{ji}^{{NC}_{ji} + {\hat{α}}_{ji} - 1} ( 1 - {θ}_{ji} )}^{{NI}_{ji} - {NC}_{ji} + {\hat{β}}_{ji} - 1}\end{matrix} \qquad ( 13 )$$

which again has the form of a Beta distribution, with posterior parameters, shown in expression (14) below:

αⱼᵢ^{p}=NCⱼᵢ+\hat{α}ⱼᵢ−1

βⱼᵢ^{p}=NIⱼᵢ−NCⱼᵢ+\hat{β}ⱼᵢ−1. (14)

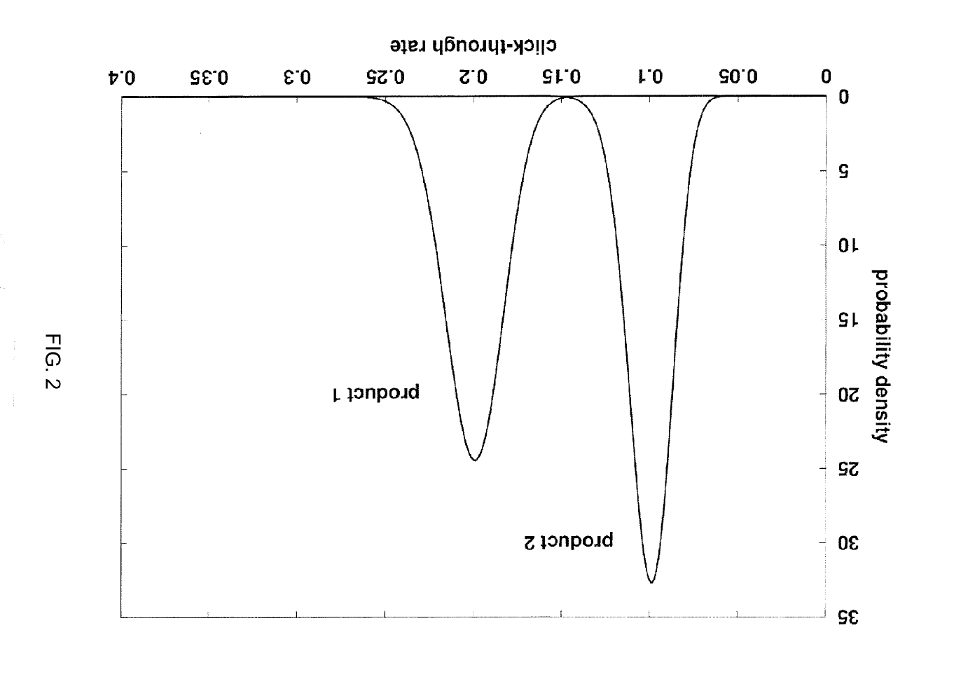

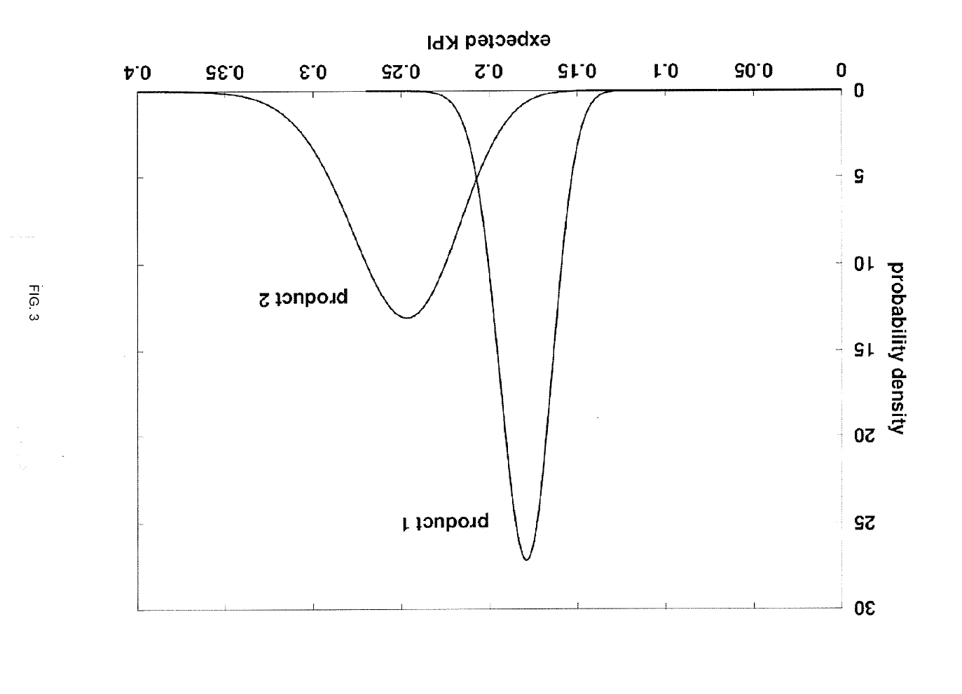

FIGS. 2 and 3 show examples of the distributions of click-through rate and expected KPI, respectively. FIG. 2 shows the posterior distributions for two products, or items. Product 1 has α^{P}=120, β^{P}=480 while product 2 has α^{P}=60, β^{P}=540. The support of the distribution of CTR for product 1 is higher than the support for the distribution of CTR for product 2. Based solely on CTR as the quality measure for recommendations, product 1 would always be chosen for recommendation. FIG. 3 shows the distributions of expected KPI. Product 1 has a BTR of 5%, and a price of $18. Product 2 has a BTR of 2.5% and a price of $100. These lead to product 2 having a distribution of expected KPI that has mostly higher support than the distribution of KPI for product 1. However, the distribution for product 1 overlaps that for product 2, so there is some chance that product 2 has a “true” expected KPI higher than that for product 1, as shown in FIG. 3.

With the distribution of CTR determined, the BTR can be considered as follows:

p(user buys rⱼ|user is viewing page pᵢ, Iₑ) (15)

As this is calculated based on every view of page pᵢ and every purchase of the item (rather than only the subset where the purchase is directly related to a guide click), it is expected that sufficient data will be available to treat this as a point value rather than a distribution. The probability can be calculated as follows:

$$\frac{\# purchases of item j}{\# of views of item j} \qquad ( 16 )$$

Thus far the distribution of the probability that a user on page pᵢ will purchase product rⱼ if shown a recommendation for product rⱼ on page pᵢ has been determined. Showing the recommendations with the highest values of these probabilities is a natural choice for which recommendations to show, but is only one choice. This choice corresponds to optimizing for conversions—each purchase has the same value to the website owner. Clearly, other KPIs may be more important to the website owner. For example, instead of showing recommendations with the highest probability of purchase, the expected KPI can be computed for each potential recommendation by forming the product of the probability of purchase and the KPI for that product. The recommendations with the highest expected KPI can thus be shown. Potential KPIs include, for example, revenue and profit margin, but could also include customer-specific indicators, based on inventory or other business concerns.

As click-through data will only be available for a small subset of all potential recommendations, and may be sufficiently sparse that the distribution of click-through rate is still somewhat broad, there is a tradeoff between exploration and exploitation. There may be a product with a low prior probability but would have a high posterior probability if it were displayed. It is difficult to determine much of the time should the current best recommendations be shown, and how much time should be spent exploring other potential recommendations to see if one of them would perform better, in terms of optimizing or at least improving the KPI in concern, than one of the current recommendations. Likewise, it is difficult to determine how to accomplish this in a way that does not impact overall KPI for the website.

As an example, the click-through rates for two items that are potential recommendations are denoted as θ₁ and θ₂. The corresponding two probability distributions p₀(θ₁) and p₀(θ₂) include two distributions over expected KPI, p(θ₁×BTR₁×KPI₁) and p(θ₂×BTR₂×KPI₂).

As shown in FIG. 3, product 2 appears to be better than product 1. However, based on the current data from which these distributions were derived, there is a chance that product 1 is actually better than product 2—if the “true” expected KPI for product 1 was in the right tail of its distribution and that for product 2 in the left tail of its distribution. The approach is to show product 2 most of the time, but also show product 1 often enough such that if it really is better than product 2 in terms of optimizing or at least improving the KPI in concern, the additional data will cause the updated distributions to reflect accordingly.

When selecting which recommendations to display to the user, a sample is generated from the distribution of expected KPI. This has the desired property that as the distributions for products 1 and 2 overlap more, the “lower rated” product appears in the recommendations more often; and as the overlap decreases, the “better” product is shown almost exclusively with no manual intervention needed.

An example implementation in accordance with the present disclosure is divided into two stages, namely the model building stage and the question time stage. The model building stage computes the αⱼᵢ and βⱼᵢ parameters of the CTR distributions for all combinations of product i and potential recommendation j, and the BTR and KPI for each product. At the question time stage, the algorithm in accordance with the present disclosure uses the matrices produced during the model building stage and, when asked for recommendations for a particular product, generates a set of potential recommendations that are passed to the merchandising unit which applies business rules to filter or re-rank the recommendations. In principle, the models (αⱼᵢ, βⱼᵢ and BTRᵢ) could be updated online as users visit the website and are served recommendations, but the separation has a number of architectural advantages in terms of data collection and run-time complexity.

The data available for model building is the cumulative history of all users of a website. The website may, for example, be instrumented to return information about visits to a page, recommendation impressions, guide clicks and purchases. This data is stored in a table, e.g., a Hive table or any other suitable table, in a data repository, and a series of Hive queries are used to build the model. An example algorithm is provided below.

Initially, the algorithm determines the set of potential product and the set of potential targets. Example action(s) taken by the algorithm include, but are not limited to, the following:
(1) Create a table of <document ID>, <number of visits>, <number of purchases>, <KPI> (where a document is associated with a respective page at the website);
(2) Limit the rows of the table in (1) to only those that were purchased more than a user-defined threshold number of times;
(3) Create a table of all possible context documents (e.g., all items that are purchased at least once); and
(4) Create a table of all possible targets (e.g., everything that is purchased more than a user-defined threshold number of times).

Then, the algorithm determines NVᵢ and NVⱼᵢ for the prior. Example action(s) taken by the algorithm include, but are not limited to, the following:
(5) Create a table of all pages viewed by all users, e.g., <user ID>, <document ID>;
(6) Create a version of (5) where the document IDs are limited to the possible context documents in (3);
(7) Create a version of (5) where the document IDs are limited to the possible targets in (4);
(8) Join tables of (6) and (7) to generate a table <context document>, <target>, <user ID>;
(9) From (8), compute <context document>, <number of users who viewed the context document>;
(10) From (8), compute <context document>, <target>, <number of users who viewed the context document who also viewed the target>; and
(11) Join (9) and (10) to generate <context document (i)>, <target (j)>, <NVᵢ>, <NVⱼᵢ>.

The table in (11) is much larger than necessary. The number of potential targets for each context document is much larger than the number of recommendations that will ever be needed for a given context document. Example action(s) taken by the algorithm include, but are not limited to, the following:
(12) From (2), create a table of <target>, <BTR×KPI>;
(13) Add a column of <BTR×KPI> to the table in (11);
(14) From (13), find the top N values of BTR×KPI for each context document; and
(15) From the table in (11), retain the targets corresponding to the top N values per context document.

The soft threshold function is applied to limit the weight of the prior. Example action(s) taken by the algorithm include, but are not limited to, the following:
(16) From (15), apply the soft threshold function to NVᵢ and NVᵢⱼ and form a table of <context document>, <target>, <α′>, <β′>.

Finally, the algorithm rescales the prior, combines the result with CTR data, and format as a set of sparse matrices.

At the question time stage, the rows of the α, β and BTR×KPI matrices corresponding to the context document are retrieved. For each entry in the row, a sample θ˜B(α, β) is generated, and multiplied by BTR×KPI. This is the “score” for that target. The vector of targets and scores is passed to the algorithm which applies any additional merchandizing rules, sorts the recommendations by score, and returns them to the user for display as part of the web page.

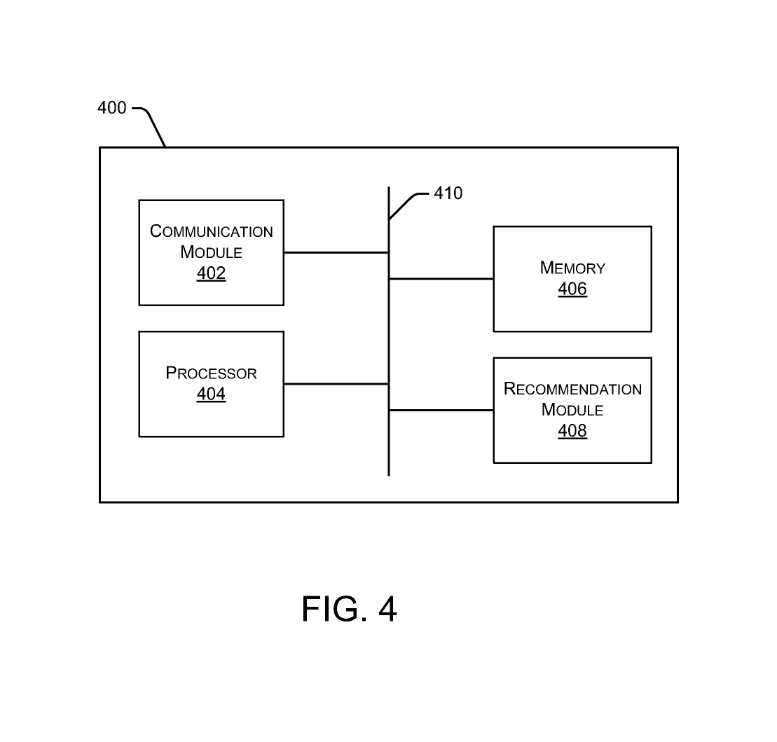

FIG. 4 illustrates an example computing device 400 configured to implement systems and methods of the present disclosure. Computing device 400 performs various functions related to the operation of back-end device 102, as discussed herein. Back-end device 102 may include one or more instances of computing device 400 that cooperatively implement the functions described herein. Computing device 400 includes a communication module 402, a processor 404, and a memory 406. Communication module 402 allows computing device 400 to communicate with other systems, such as communication networks, other servers, front-end device 104, etc. Processor 404 executes one or more sets instructions to implement the functionality provided by computing device 400. Memory 406 stores those one or more sets of instructions as well as other data used by processor 404 and other modules contained in computing device 400. Computing device 400 also includes a recommendation module 408, which serves product recommendation for KPI optimization as described herein. For illustrative purposes, recommendation module 408 is shown in FIG. 4 as an individual module separate from processor 404. In some implementations, however, recommendation module 408 may be an integral part of processor 404. A data communication bus 410 allows the various systems and components of computing device 400 to communicate with each other.

Memory 406 may store data and one or more sets of instructions, and processor 404 may execute the one or more sets of instructions and control communication module 402 and recommendation module 408. For example, processor 404 may control recommendation module 408 to select at least a first item from a set of items such that a first performance indicator among a plurality of performance indicators is improved as a result of a user purchasing the first item in response to viewing at least the first item on a webpage of a website. Processor 404 may also control communication module 402 to communicate with a display device, e.g., front-end device 104 which has a screen or display panel, to displays a graphic or textual representation of at least the first item on the webpage as a recommendation to the user.

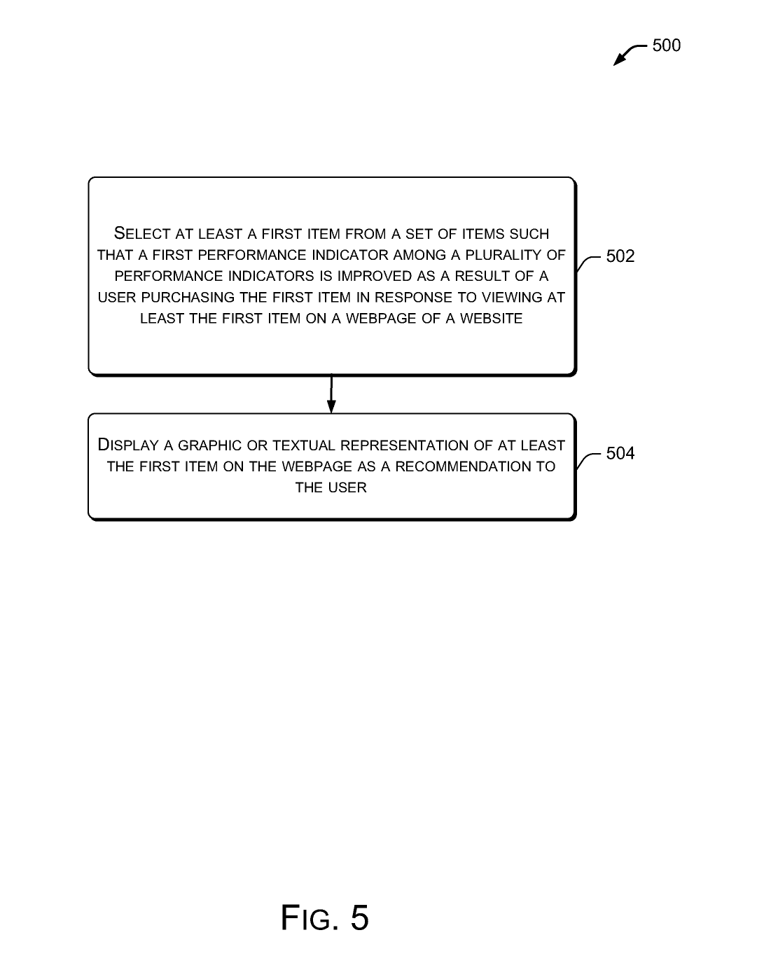

FIG. 5 illustrates an example process 500 for serving product recommendations for KPI optimization. Example process 500 includes one or more operations, actions, or functions as illustrated by one or more of blocks 502 and 504. Although illustrated as discrete blocks, various blocks may be divided into additional blocks, combined into fewer blocks, or eliminated, depending on the desired implementation. Process 500 may be implemented by one or more processors including, for example, one or more processors of back-end device 102 and processor 404 of computing device 400. For illustrative purposes, the operations described below are performed by one or more processors of computing device 400 as shown in FIG. 4.

At 502, processor 404 of computing device 400 may select at least a first item from a set of items such that a first performance indicator among a plurality of performance indicators is improved as a result of a user purchasing the first item in response to viewing at least the first item on a webpage of a website.

At 504, processor 404 of computing device 400 may cause communication module 402 of computing device 400 to display a graphic or textual representation of at least the first item on the webpage as a recommendation to the user.

In one embodiment, the plurality of performance indicators, e.g., KPIs, may include revenue, profit margin, inventory and one or more user-specific indicators.

In one embodiment, in selecting at least the first item from the set of items, processor 404 may compute a probability distribution related to a likelihood of the user purchasing the first item from among a subset of items of the set of items when the subset of items are displayed to the user on the webpage.

In one embodiment, the probability distribution may be proportion to a product of a click-through rate and a buy-through rate. The click-through rate may be related to a likelihood of the user clicking on the graphic or textual representation of the first item on the webpage when the user is viewing the webpage. The buy-through rate may be related to a likelihood of the user purchasing the first item when the user is viewing the webpage.

In one embodiment, in computing the probability distribution, processor 404 may approximate the click-through rate using data on co-viewing of one or more other items from the set of items that are displayed on the webpage with the first item.

In one embodiment, in computing the probability distribution, processor 404 may compute a prior probability distribution, e.g., a probability distribution that is related to a first parameter and a second parameter. In other embodiments, one or more other different probability distributions may be calculated to define the CTR distribution. The first parameter may be associated with a number of users who viewed the first item on the webpage, and the second parameter may be associated with a number of users who viewed the first item who also viewed another item from the set of items on the webpage. Processor 404 may also apply a soft-threshold function to the first and the second parameters to limit the prior probability distribution to be equivalent to an action of a plurality of pseudo-visitors to the website.

In one embodiment, in computing the probability distribution, processor 404 may also perform operations including: scaling the prior probability distribution to provide a rescaled prior probability distribution; and combining a probability of a likelihood of the user clicking on a graphic or textual representation of the first item on the webpage when the user is viewing the webpage and a Beta function of parameters of the scaled, soft-thresholded prior probability distribution to provide a posterior probability distribution.

In one embodiment, in computing the probability distribution, processor 404 may compute the probability distribution based at least in part on information about the user and information about one or more other users.

In one embodiment, the information about the user may include some or all of information related to at least one previous transaction (e.g., purchase) or action taken by the user on the website (e.g., navigating, viewing a page of the website, clicking on an icon on a page of the website, etc.), a location of the user, demographic information of the user, and a social network of the user.

In one embodiment, the information about the one or more other users may include some or all of information related to one or more other items from the set of items viewed by the one or more other users on the website, one or more other webpages of the website viewed by the one or more other users, at least one previous transaction or action taken by each of the one or more other users on the website, a location of each of the one or more other users, demographic information of the one or more other users, a social network of each of the one or more other users, and time of a year at a time of the computing.

Optionally, process 500 may additionally involve processor 404 receiving, prior to the selecting, a user input that selects the first performance indicator from the plurality of performance indicators.

Optionally, process 500 may additionally involve processor 404 performing operations including: computing a value of an expected performance indicator for a recommendation associated with each item of the set of items; selecting a second item of the set of items having a highest value of the expected performance indicator; and displaying a graphic or textual representation of at least the second item on the webpage as a recommendation to the user.

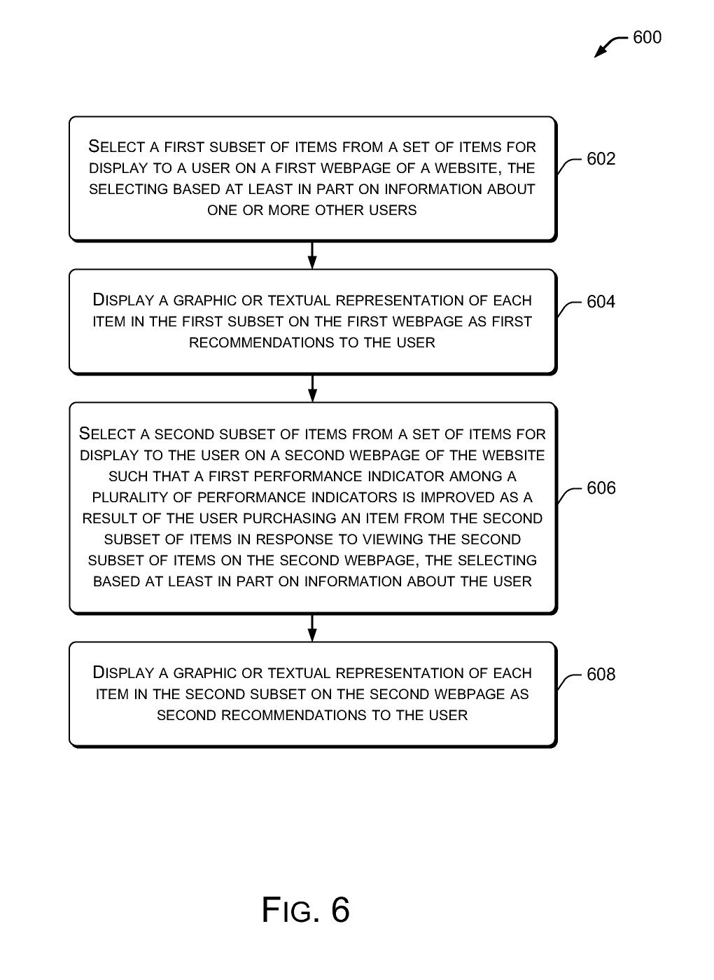

FIG. 6 illustrates an example process 600 for optimally ordering recommendation or search results. Example process 600 includes one or more operations, actions, or functions as illustrated by one or more of blocks 602, 604, 606 and 608. Although illustrated as discrete blocks, various blocks may be divided into additional blocks, combined into fewer blocks, or eliminated, depending on the desired implementation. Process 600 may be implemented by one or more processors including, for example, one or more processors of back-end device 102 and processor 404 of computing device 400. For illustrative purposes, the operations described below are performed by processor 404 of computing device 400 as shown in FIG. 4.

At 602, processor 404 of computing device 400 may select a first subset of items from a set of items for display to a user on a first webpage of a website, the selecting based at least in part on information about one or more other users.

At 604, processor 404 of computing device 400 may cause communication module 402 of computing device 400 to display a graphic or textual representation of each item in the first subset on the first webpage as first recommendations to the user.

At 606, processor 404 of computing device 400 may select a second subset of items from a set of items for display to the user on a second webpage of the website such that a first performance indicator among a plurality of performance indicators is improved as a result of the user purchasing an item from the second subset of items in response to viewing the second subset of items on the second webpage, the selecting based at least in part on information about the user.

At 608, processor 404 of computing device may cause communication module 402 of computing device 400 to display a graphic or textual representation of each item in the second subset on the second webpage as second recommendations to the user.

In one embodiment, the plurality of performance indicators, e.g., KPIs, may include revenue, profit margin, inventory and one or more user-specific indicators.

In one embodiment, the information about the user may include some or all of information related to at least one previous transaction (e.g., purchase) or action taken (e.g., navigating, viewing a page of the website, clicking on an icon on a page of the website, etc.) by the user on the website, a location of the user, demographic information of the user, and a social network of the user.

In one embodiment, the information about the one or more other users may include some or all of information related to one or more other items from the set of items viewed by the one or more other users on the website, one or more other webpages of the website viewed by the one or more other users, at least one previous transaction or action taken by each of the one or more other users on the website, a location of each of the one or more other users, demographic information of the one or more other users, a social network of each of the one or more other users, and time of a year at a time of the computing.

In one embodiment, in selecting the first subset of items from the set of items, processor 404 may compute a probability distribution related to a likelihood of the user purchasing a first item from among the first subset of items when the first subset of items are displayed to the user on the first webpage. In computing the probability distribution, processor 404 may compute a prior probability distribution, e.g., a probability distribution that is related to a first parameter and a second parameter. In other embodiments, one or more other different probability distributions may be calculated to define the CTR distribution. The first parameter may be associated with a number of users who viewed the first item on the first webpage, and the second parameter may be associated with a number of users who viewed the first item who also viewed another item from the set of items on the first webpage. Processor 404 may also apply a soft-threshold function to the first and the second parameters to limit the prior probability distribution to be equivalent to an action of a plurality of pseudo-visitors to the website. Processor 404 may further scale the prior probability distribution to provide a rescaled prior probability distribution, and combine a probability of a likelihood of the user clicking on a graphic or textual representation of the first item on the first webpage when the user is viewing the first webpage and a Beta function of parameters of the scaled, soft-thresholded prior probability distribution to provide a posterior probability distribution.

Optionally, process 500 may additionally involve processor 404 receiving, prior to the selecting, a user input that selects the first performance indicator from the plurality of performance indicators.

Optionally, process 500 may additionally involve processor 404 performing operations including: computing a value of an expected performance indicator for a recommendation associated with each item of the set of items; selecting a second item of the set of items having a highest value of the expected performance indicator; and displaying a graphic or textual representation of at least the second item on the webpage as a recommendation to the user.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
selecting, by one or more processors, at least a first item from a set of items such that a first performance indicator among a plurality of performance indicators is improved as a result of a user purchasing the first item in response to viewing at least the first item on a webpage of a website; and
displaying a graphic or textual representation of at least the first item on the webpage as a recommendation to the user.

2. The method of claim 1, wherein the plurality of performance indicators comprise revenue, profit margin, inventory and one or more user-specific indicators.

3. The method of claim 1, where the selecting comprises:
computing a probability distribution related to a likelihood of the user purchasing the first item from among a subset of items of the set of items when the subset of items are displayed to the user on the webpage.

4. The method of claim 3, wherein the probability distribution is proportion to a product of a click-through rate and a buy-through rate, wherein the click-through rate is related to a likelihood of the user clicking on the graphic or textual representation of the first item on the webpage when the user is viewing the webpage, and wherein the buy-through rate is related to a likelihood of the user purchasing the first item when the user is viewing the webpage.

5. The method of claim 4, wherein the computing the probability distribution comprises approximating the click-through rate using data on co-viewing of one or more other items from the set of items that are displayed on the webpage with the first item.

6. The method of claim 3, wherein the computing the probability distribution comprises:
computing a prior probability distribution related to a first parameter and a second parameter, the first parameter associated with a number of users who viewed the first item on the webpage, the second parameter associated with a number of users who viewed the first item who also viewed another item from the set of items on the webpage; and
applying a soft-threshold function to the first and the second parameters to limit the prior probability distribution to be equivalent to an action of a plurality of pseudo-visitors to the website.

7. The method of claim 6, wherein the computing the probability distribution further comprises:
scaling the prior probability distribution to provide a rescaled prior probability distribution; and
combining a probability of a likelihood of the user clicking on a graphic or textual representation of the first item on the webpage when the user is viewing the webpage and a Beta function of parameters of the scaled, soft-thresholded prior probability distribution to provide a posterior probability distribution.

8. The method of claim 3, wherein the computing comprises computing based at least in part on information about the user and information about one or more other users.

9. The method of claim 8, wherein the information about the user comprises some or all of information related to at least one previous transaction or action taken by the user on the website, a location of the user, demographic information of the user, and a social network of the user.

10. The method of claim 8, wherein the information about the one or more other users comprises some or all of information related to one or more other items from the set of items viewed by the one or more other users on the website, one or more other webpages of the website viewed by the one or more other users, at least one previous transaction by each of the one or more other users on the website, a location of each of the one or more other users, demographic information of the one or more other users, a social network of each of the one or more other users, and time of a year at a time of the computing.

11. The method of claim 1, further comprising:
receiving, by the one or more processors prior to the selecting, a user input that selects the first performance indicator from the plurality of performance indicators.

12. The method of claim 1, further comprising:
computing, by the one or more processors, a value of an expected performance indicator for a recommendation associated with each item of the set of items;
selecting a second item of the set of items having a highest value of the expected performance indicator; and
displaying a graphic or textual representation of at least the second item on the webpage as a recommendation to the user.

13. A method comprising:
selecting, by one or more processors, a first subset of items from a set of items for display to a user on a first webpage of a website, the selecting based at least in part on information about one or more other users;
displaying a graphic or textual representation of each item in the first subset on the first webpage as first recommendations to the user;
selecting, by one or more processors, a second subset of items from a set of items for display to the user on a second webpage of the website such that a first performance indicator among a plurality of performance indicators is improved as a result of the user purchasing an item from the second subset of items in response to viewing the second subset of items on the second webpage, the selecting based at least in part on information about the user; and
displaying a graphic or textual representation of each item in the second subset on the second webpage as second recommendations to the user.

14. The method of claim 13, wherein the plurality of performance indicators comprise revenue, profit margin, inventory and one or more user-specific indicators.

15. The method of claim 13, wherein the information about the user comprises some or all of information related to at least one previous transaction or action taken by the user on the website, a location of the user, demographic information of the user, and a social network of the user.

16. The method of claim 13, wherein the information about the one or more other users comprises some or all of information related to one or more other items from the set of items viewed by the one or more other users on the website, one or more other webpages of the website viewed by the one or more other users, at least one previous transaction or action taken by each of the one or more other users on the website, a location of each of the one or more other users, demographic information of the one or more other users, a social network of each of the one or more other users, and time of a year at a time of the computing.

17. The method of claim 13, where the selecting the first subset of items from the set of items comprises:
computing a probability distribution related to a likelihood of the user purchasing a first item from among the first subset of items when the first subset of items are displayed to the user on the first webpage, wherein the computing the probability distribution comprises:
computing a prior probability distribution related to a first parameter and a second parameter, the first parameter associated with a number of users who viewed the first item on the first webpage, the second parameter associated with a number of users who viewed the first item who also viewed another item from the set of items on the first webpage;
applying a soft-threshold function to the first and the second parameters to limit the prior probability distribution to be equivalent to an action of a plurality of pseudo-visitors to the website;
scaling the prior probability distribution to provide a rescaled prior probability distribution; and
combining a probability of a likelihood of the user clicking on a graphic or textual representation of the first item on the first webpage when the user is viewing the first webpage and a Beta function of parameters of the scaled, soft-thresholded prior probability distribution to provide a posterior probability distribution.

18. The method of claim 13, further comprising:
receiving, by the one or more processors prior to the selecting, a user input that selects the first performance indicator from the plurality of performance indicators.

19. The method of claim 13, further comprising:
computing, by the one or more processors, a value of an expected performance indicator for a recommendation associated with each item of the set of items;
selecting a second item of the set of items having a highest value of the expected performance indicator; and
displaying a graphic or textual representation of at least the second item on the webpage as a recommendation to the user.

20. An apparatus comprising:
a memory configured to store data and one or more sets of instructions; and
one or more processors coupled to the memory, the one or more processors configured to execute the one or more sets of instructions and perform operations comprising:
selecting, by one or more processors, at least a first item from a set of items such that a first performance indicator among a plurality of performance indicators is improved as a result of a user purchasing the first item in response to viewing at least the first item on a webpage of a website; and
displaying a graphic or textual representation of at least the first item on the webpage as a recommendation to the user.
